(19) United States
(12) Patent Application Publication
(10) Pub. No.: US 2014/0140899 A1
(43) Pub. Date: May 22, 2014

(54) CATALYSED PARTICULATE FILTER AND METHOD FOR THE PREPARATION OF A CATALYSED PARTICULATE FILTER

(71) Applicants: Pär L. Gabrielsson, Helsingborg (SE); Keld Johansen, Frederikssund (DK)

(72) Inventors: Pär L. Gabrielsson, Helsingborg (SE); Keld Johansen, Frederikssund (DK)

(73) Assignee: Haldor Topsøe A/S, Kgs. Lyngny (DK)

(21) Appl. No.: 14/127,762

(22) PCT Filed: Jun. 14, 2012
(86) PCT No.: PCT/EP2012/061329

§ 371 Date: Dec. 19, 2013

(30) Foreign Application Priority Data
Jul. 13, 2011 (DK) PA 2011 00538

(51) Int. Cl. F01N 3/20; B05D 1/18; B05D 1/12; F01N 3/10

(52) U.S. Cl. CPC F01N 3/2066; F01N 3/101; B05D 1/18; B05D 1/12
USPC 422/171; 427/201

(57) ABSTRACT

Wall flow particulate filter catalysed at its inlet side with a catalyst having activity in the removal of residual hydro-carbons and carbon monoxide and catalysing at rich burn engine operation conditions the reaction of nitrogen oxides with hydrogen and/or carbon monoxide to ammonia and catalysed at its outlet side with a catalyst having activity in the selective reduction of NOx by reaction with ammonia being formed in the inlet side.

The present invention relates to a multifunctional catalysed engine exhaust particulate filter. In particular, the invention is a wall flow particulate filter being catalysed at its inlet side with a three way catalyst (TWC) having activity in the removal of residual hydrocarbons and carbon monoxide and catalysing at rich burn engine operation conditions the reaction of nitrogen oxides with hydrogen and/or carbon monoxide to ammonia. On its outlet side the filter is coated with a catalyst removing nitrogen oxides by the known NH3—selective catalytic reduction (SCR) process, and optionally with a catalyst having activity in the oxidation of excess ammonia to nitrogen.

The invention provides furthermore a method of preparing catalysed particle filter the multifunctional catalysed particulate filter according to the invention.

The multifunctional catalysed filter is in particular useful for the cleaning of exhaust gas from lean burn gasoline engines, such as the gasoline direct injection (GDI) engine.

GDI engines generate more carbonaceous soot than gasoline premixed injection engines. In Europe the Euro 5+Diesel legislation is expected to be used for GDI in the future with a particulate mass limit at 4.5 mg/km, which requires filtration of the engine exhaust in order to reach the above limit.

Typically, filters of the wall flow type are honeycombed wall flow filters, wherein particulate matter is captured on or in partition walls of the honeycomb filter. These filters have a plurality longitudinal flow channels separated by gas permeable partition walls. Gas inlet channels are open at their gas inlet side and blocked at the opposite outlet end and the gas outlet channels are open at the outlet end and blocked the inlet end, so that a gas stream entering the wall flow filter is forced through the partition walls before into the outlet channels.

In addition to soot particles exhaust gas from lean burn gasoline engines contains nitrogen oxides (NOx), carbon monoxide and unburnt hydrocarbons, which are chemical compounds representing a health and environmental risk and must be reduced or removed from the engine exhaust gas.

Catalysts being active in the removal or reduction of NOx, carbon monoxide and unburnt hydrocarbons to harmless are per se known in the art.

The patent literature discloses numerous cleaning systems comprising separate catalyst units for the removal of harmful compounds from engine exhaust gas.

Also known in the art are exhaust gas particulate filters coated with catalysts catalysing oxidation of unburnt hydrocarbons and particulate matter together with selective catalytic reduction (SCR) of NOx by reaction with ammonia being added as such or as precursor thereof.

The present invention makes use of the ability of certain catalysts to form ammonia by reaction with hydrocarbon and unburnt hydrocarbons to combine ammonia SCR and removal of particles exhaust gas from gasoline engines.

Thus, the invention provides a catalysed wall flow filter consisting of a plurality longitudinal inlet flow channels and outlet flow channels separated by gas permeable porous partition walls, each inlet flow channel having an open inlet end and a closed outlet end, and each outlet flow channel having a closed inlet end and an open outlet end, wherein
each inlet flow channel comprises a first catalyst being active in reaction of nitrogen oxides with carbon monoxide and hydrogen to ammonia;
each outlet channel comprises a second catalyst being active in selective reduction of nitrogen oxides by reaction with ammonia to nitrogen;
and wherein the mode particle size of either the first or the second catalyst is less than mean pore size of the gas permeable porous partition walls and mode particle size of the catalyst having not the less mode particle size is larger than the mean pore size of the gas permeable partition walls.

The advantage of either the first or second catalyst have a less particle size than the mean pore diameter of the partition walls and the other catalyst particles have a larger particle size than the mean pore diameter of the walls is to allow one of the catalysts to diffuse effectively into the partition walls and to prevent the other catalyst from diffusing into the channels where the specific catalytic activity is nor desired.

Useful catalyst for the reaction of NOx to ammonia by the following reaction:

NOx+H₂/CO=NH₃+CO₂+H₂O

are palladium, platinum, a mixture of palladium and rhodium and a mixture of palladium, platinum and rhodium.

These catalysts catalyse the ammonia formation under rich burn operating conditions of the gasoline engine, i.e. λ<1. Palladium is the preferred catalyst with the highest ammonia formation.

Ammonia being thus formed within the inlet channels by the above reaction permeates through the partition walls of the filter into the outlet channels and is during the rich operating conditions adsorbed in the SCR catalyst in the outlet flow channels.

Both the ammonia forming catalyst and the SCR catalyst are preferably deposited on the partition walls on the sides facing the inlet channel and the outlet channel, respectively.

In a subsequent lean burn operation cycle of the engine, NOx being present in the exhaust gas reacts with the ammonia stored in the SCR catalyst by the following reaction:

NOx+NH₃=N₂+H₂O

As already mentioned above, SCR catalysts are per se known in the art. For use in the invention, the preferred catalyst being active in the selective reduction of nitrogen oxides comprises at least one of a zeolite, a silica aluminum phosphate, an ion exchanged zeolite, silica aluminum phosphate promoted with iron and/or copper, one or more base metal oxides.

A further preferred SCR catalyst for use in the invention is a silica aluminium phosphate with chabazite structure, such as SAPO 34, promoted with copper and/or iron.

In order to remove excess ammonia having not reacted with NOx, the wall flow filter comprises in an embodiment of the invention additionally an ammonia oxidation catalyst arranged in each outlet flow channel at least in the region of the outlet end of the filter.

A preferred ammonia oxidation catalyst comprises palladium, platinum or a mixture thereof.

By contact with the ammonia oxidation catalyst coated on a part of the SCR catalyst coat, ammonia is selectively oxidised to nitrogen and water.

The ammonia oxidation catalyst may be deposited directly on the partition wall in the outlet channels of the filter in the outlet region or may be provided as surface layer on upper surface of the SCR catalyst layer facing away from the partition walls.

The invention provides additionally a method of preparation of a catalysed wall flow filter.

In its broad embodiment, the method according to the invention comprises the steps of
a) providing a wall flow filter body with a plurality longitudinal inlet flow channels and outlet flow channels separated by gas permeable partition walls, each inlet flow channel having an open inlet end and a closed outlet end, and each outlet flow channel having a closed inlet end and an open outlet end,;
b) providing a first catalyst washcoat containing a first catalyst composition being active in reaction of nitrogen oxides with carbon monoxide and hydrogen to ammonia;
c) providing a second catalyst washcoat containing a second catalyst composition being active in selective reduction of nitrogen oxides by reaction with ammonia to nitrogen;
d) coating the inlet flow channels of the filter body with the first catalyst washcoat;
e) coating the outlet flow channels of the filter body with the second catalyst washcoat; and
f) drying and heat treating the coated filter body to obtain the catalysed wall flow filter, wherein the mode particle size of either the first or the second catalyst washcoat is less than mean pore size of the gas permeable partition walls and mode particle size of the catalyst washcoat having not the less mode particle size is larger than the mean pore size of the gas permeable partition walls.

In further a broad embodiment plugging of the outlet end and the inlet end of the inlet channels and outlet channels, respectively, may be carried out after coating of the channels.

Thus, the invention is furthermore a method of preparation a catalysed wall flow filter, comprising the steps of
a) providing a wall flow filter body with a plurality longitudinal inlet flow channels and outlet flow channels separated by gas permeable partition walls;
b) providing a first catalyst washcoat containing a first catalyst composition being active in reaction of nitrogen oxides with carbon monoxide and hydrogen to ammonia;
c) providing a second catalyst washcoat containing a second catalyst composition being active in selective reduction of nitrogen oxides by reaction with ammonia to nitrogen;
d) coating the inlet flow channels of the filter body with the first catalyst washcoat;
e) coating the outlet flow channels of the filter body with the second catalyst washcoat;
f) plugging outlet ends of the thus coated inlet flow channels and plugging inlet ends of the thus coated outlet flow channels; and
g) drying and heat treating the coated filter body to obtain the catalysed wall flow filter, wherein mode particle size of either the first or the second catalyst in the washcoats is less than mean pore size of the gas permeable partition walls and the mode particle size of the catalyst in the washcoat having not the less mode particle size is larger than the mean pore size of the gas permeable partition walls.

Specific catalyst compositions for use in the invention are mentioned hereinbefore and further disclosed in claims 9 to 11.

In further an embodiment of the invention, the filter is additionally coated with a so called ammonia slip catalyst, which is a catalyst being active in the oxidation of excess of ammonia to nitrogen and water.

Thus in this embodiment the inventive method comprises the steps of providing a third washcoat containing a third catalyst being active in the oxidation of ammonia; and coating at least a part of the outlet channels with the third washcoat subsequently to the coating with the second washcoat.

When preparing the washcoats for use in the invention, the catalysts being usually in particle form are milled or agglomerated to the required particle size and suspended in water or organic solvents, optionally with addition of binders, viscosity improvers, foaming agents or other processing aids.

The filter is then washcoated according to common practice, including applying vacuum in the filter, pressurizing the washcoat or by dip coating.

The amount of the catalyst having a mode particle size less than the mean pore size of the partition wall of the filter is typically 20 to 140 g/l, and the amount of the catalyst with a larger mode particle size is typically 10 to 100 g/l. The total catalyst loading on the filter is typically in the range of 40 to 200 g/l.

Examples of suitable filter materials for use in the invention are silicon carbide, aluminium titanate, cordierite, alumina, mullite or combinations thereof.

### EXAMPLE

A suspension of the first catalyst composition is in a first step prepared from a powder mixture of palladium rhodium deposited on cerium oxide and alumina particles with a mode particle size larger than the filter wall mean pore size.

A suspension of the mixture first catalyst is prepared by mixing 20 g of these powders in 40 ml demineralised water pr liter filter. A dispersing agent Zephrym PD-7000 and an antifoam agent are added. The particle sizes of the final suspension must be larger than the mean pore diameter of the pores in the wall of the wall flow filter

A suspension of a second catalyst is made by mixing and dispersing 100 g of silica aluminium phosphate SAPO-34 promoted with 2% copper in 200 ml demineralised water pr liter filter. A dispersing agent Zephrym PD-7000 and an antifoam agent are added. The suspension is milled in a bead mill. The particle sizes must be lower than the mean pore diameter of the pores in the wall of the wall flow filter

A conventional high porosity (approximately 60% and wall mean pore size approx 18 μm) plugged SiC wall flow filter body is applied.

The first catalyst suspension is washcoated (100 g/ft3) on the filter from the inlet end of the filters dispersions side by standard washcoat methods, dried and calcined at 750° C.

The second catalyst suspension is washcoated on the filter from the outlet end of the filters permeate side by standard washcoat methods, dried and calcined at 750° C.

1. A catalysed wall flow filter consisting of a plurality longitudinal inlet flow channels and outlet flow channels separated by gas permeable porous partition walls, each inlet flow channel having an open inlet end and a closed outlet end, and each outlet flow channel having a closed inlet end and an open outlet end, wherein
each inlet flow channel comprises a first catalyst being active in reaction of nitrogen oxides with carbon monoxide and hydrogen to ammonia;
each outlet channel comprises a second catalyst being active in selective reduction of nitrogen oxides by reaction with ammonia to nitrogen;
and wherein the mode particle size of either the first or the second catalyst is less than mean pore size of the gas permeable porous partition walls and mode particle size of the catalyst having not the less mode particle size is larger than the mean pore size of the gas permeable partition walls.

2. Catalysed wall flow filter according to claim 1, wherein the catalyst being active in conversion of nitrogen oxides to ammonia includes palladium, platinum, a mixture of palladium and rhodium and a mixture of palladium, platinum and rhodium.

3. Catalysed wall flow filter according to claim 1, wherein the catalyst being active in conversion of nitrogen oxides to ammonia consists of palladium.

4. Catalysed wall flow filter according to claim 1, wherein the catalyst being active in the selective reduction of nitrogen oxides comprises at least one of a zeolite, a silica aluminum phosphate, an ion exchanged zeolite, silica aluminum phosphate promoted with iron and/or copper, one or more base metal oxides.

5. Catalysed wall flow filter according to claim 1, further comprising an ammonia oxidation catalyst arranged in each outlet flow channel.

6. Catalysed wall flow filter according to claim 5, wherein the ammonia oxidation catalyst comprises palladium, platinum or a mixture thereof.

7. Method of preparation a catalysed wall flow filter, comprising the steps of
a) providing a wall flow filter body with a plurality longitudinal inlet flow channels and outlet flow channels separated by gas permeable partition walls;
b) providing a first catalyst washcoat containing a first catalyst composition being active in reaction of nitrogen oxides with carbon monoxide and hydrogen to ammonia;
c) providing a second catalyst washcoat containing a second catalyst composition being active in selective reduction of nitrogen oxides by reaction with ammonia to nitrogen;
d) coating the inlet flow channels of the filter body with the first catalyst washcoat;
e) coating the outlet flow channels of the filter body with the second catalyst washcoat;
f) plugging outlet ends of the thus coated inlet flow channels and plugging inlet ends of the thus coated outlet flow channels; and
g) drying and heat treating the coated filter body to obtain the catalysed wall flow filter, wherein mode particle size of either the first or the second catalyst in the washcoats is less than mean pore size of the gas permeable partition walls and the mode particle size of the catalyst in the washcoat having not the less mode particle size is larger than the mean pore size of the gas permeable partition walls.

8. Method of preparation a catalysed wall flow filter, comprising the steps of
a) providing a wall flow filter body with a plurality longitudinal inlet flow channels and outlet flow channels separated by gas permeable partition walls, each inlet flow channel having an open inlet end and a closed outlet end, and each outlet flow channel having a closed inlet end and an open outlet end;
b) providing a first catalyst washcoat containing a first catalyst composition being active in reaction of nitrogen oxides with carbon monoxide and hydrogen to ammonia;
c) providing a second catalyst washcoat containing a second catalyst composition being active in selective reduction of nitrogen oxides by reaction with ammonia to nitrogen;
d) coating the inlet flow channels of the filter body with the first catalyst washcoat;
e) coating the outlet flow channels of the filter body with the second catalyst washcoat; and
f) drying and heat treating the coated filter body to obtain the catalysed wall flow filter, wherein mode particle size of either the first or the second catalyst in the washcoats is less than mean pore size of the gas permeable partition walls and the mode particle size of the catalyst in the washcoat having not the less mode particle size is larger than the mean pore size of the gas permeable partition walls.

9. The method of claim 7, wherein the catalyst being active in conversion of nitrogen oxides to ammonia includes palladium, platinum, a mixture of palladium and rhodium and a mixture of palladium, platinum and rhodium.

10. The method of claim 7, wherein the catalyst being active in the conversion of nitrogen oxides to ammonia consists of palladium.

11. The method according to claim 7, wherein the catalyst being active in the selective reduction of nitrogen oxides comprises at least one of a zeolite, a silica aluminum phosphate, an ion exchanged zeolite, silica aluminum phosphate promoted with iron and/or copper, and one or more base metal oxides.

12. The method according to claim 7, comprising the further steps of providing a third washcoat containing a third catalyst being active in the selective oxidation of ammonia; and
coating at least a part of the outlet channels with the third washcoat subsequently to the coating with the second washcoat.
